(19) United States
(12) Patent Application Publication
(10) Pub. No.: US 2017/0353139 A1
(43) Pub. Date: Dec. 7, 2017

(54) CONTROL METHOD AND SYSTEM FOR CONVERTER OF VEHICLE

(71) Applicant: HYUNDAI MOTOR COMPANY, Seoul (KR)

(72) Inventors: Jun Mo AN, Hwaseong-si (KR); Su Hyun BAE, Daegu (KR); Sung Kyu KIM, Bucheon-si (KR); Joo Young PARK, Yongin-si (KR)

(21) Appl. No.: 15/383,716

(22) Filed: Dec. 19, 2016

(30) Foreign Application Priority Data
Jun. 7, 2016 (KR) 10-2016-0070033

(51) Int. Cl. H02P 27/06; B60L 11/18

(52) U.S. Cl. CPC H02P 27/06; B60L 11/1809; B60L 11/18; B60L 2210/40

(57) ABSTRACT

A control method of a converter of a vehicle comprises: deriving, by a controller, an energy gain of a drive motor and an energy loss of a converter in the case that the converter constituting a vehicle power conversion system is operating in a boosting mode; comparing, by the controller, the energy gain of the drive motor with the energy loss of the converter; and a step of adjusting, by the controller, a voltage command of the converter depending on a comparison result.

### CROSS REFERENCE TO RELATED APPLICATION

The present application claims the benefit of priority to Korean Patent Application No. 10-2016-0070033 filed on Jun. 7, 2016, the entire content of which is incorporated herein for all purposes by this reference.

### TECHNICAL FIELD

The present disclosure relates to a control method and system for a converter of a vehicle capable of controlling a converter as a power system constituting a vehicle in the light of an overall energy efficiency of a vehicle.

### BACKGROUND

A hybrid vehicle efficiently combines with different two or more power source. In most cases, the hybrid vehicle is driven by an engine obtaining a rotational power by combusting a fuel (fossil fuel such as gasoline) and a motor obtaining a rotational power through a battery power.

The hybrid vehicle can travel with drive modes such as an electric (EV) mode as a pure electric vehicle mode using only the power of an electric motor, a hybrid electric vehicle (HEV) mode using a rotational power of an engine as primary power while using a rotational power of a drive motor as assist power, and a regenerative braking mode recovering a driving brake energy by braking or inertia of a vehicle and an inertial energy through generation of a drive motor and charging it to a battery.

As the hybrid vehicle uses with mechanical energy of an engine and electrical energy of a battery, uses Optimum operating region of the engine and drive motor and recovers energy to a drive motor when braking, it is able to improve fuel efficiency and efficiently use energy.

Typically, the hybrid vehicle typically using two or more power sources can configure a variety of power transmission structure through an engine and a drive motor as a power source. Most current hybrid vehicles have adopted one of the power train structures of parallel or serial type.

The serial type is the type that the engine and the motor is directly connected with each other, and has the merits of simple structure and simple control logic compared to the parallel type. However, the serial type is disadvantageous to the energy conversion since it stores the mechanical energy from the engine to the battery and then drives the hybrid vehicle using the motor again.

On the other hand, the parallel type has been widely adapted to a car, and so on, since it is possible the efficient use of energy because of simultaneously using the mechanical energy of the engine and the electric energy of the battery while it has demerits of relatively complex control logic compared to the serial type. Therefore, the study about the vehicle electric power conversion system capable of improving the energy efficiency of a hybrid vehicle by using the electrical energy of the battery properly in such the parallel type has been made actively.

The foregoing is intended merely to aid in the understanding of the background of the present disclosure, and is not intended to mean that the present disclosure falls within the purview of the related art that is already known to those skilled in the art.

### SUMMARY

The present disclosure has been made keeping in mind the above problems occurring in the related art, and the present disclosure is intended to propose a control method and system for a converter of a vehicle capable of improving the energy efficiency of the overall vehicle power conversion system by deciding converter voltage command considering energy loss of a converter due to boosting as well as energy gain of a drive motor due to boosting of the converter in the vehicle power conversion system.

According to an exemplary embodiment of the present disclosure, a control method of a converter of a vehicle for achieving the above object may include: deriving, by controller, an energy gain of a drive motor and an energy loss of a converter when the converter is operating in a boosting mode; comparing, by the controller, the energy gain of the drive motor with the energy loss of the converter; and adjusting, by the controller, a voltage command of the converter depending on a comparison result in the controller.

The energy gain of the drive motor may be an energy gain of an inverter which is generated by boosting of the inverter connected between the drive motor and the converter as the converter is operated in the boosting mode.

The energy loss of the converter may be derived by the controller using a request output of the drive motor, a switching frequency of the converter, a battery voltage and a boosted output voltage of the converter.

The step of adjusting the voltage command of the converter may be that the controller adjusts the voltage command of the converter to the battery voltage when the energy gain of the drive motor is equal to or less than the energy loss of the converter.

The step of adjusting the voltage command of the converter may be that the controller operates the converter with the boosting mode and adjusts the voltage command of the converter to a final voltage command derived by using magnetic flux and a rotational speed of the drive motor and the battery voltage when the energy gain of the drive motor is greater than the energy loss of the converter.

According to another exemplary embodiment of the present disclosure, a converter system of a vehicle according to the present disclosure may include: a drive motor supplying a rotational power to a drive shaft of a vehicle; a chargeable and dischargeable battery; a converter connected between the drive motor and the battery and converting an output voltage of the battery into an operating voltage for operating the drive motor; and a controller deriving an energy gain of the drive motor and an energy loss of the converter when the converter is operating in a boosting mode, comparing the energy gain of the drive motor with the energy loss of the converter, and adjusting a voltage command of the converter depending on the comparison result.

The converter system of a vehicle may further include an inverter being connected between the converter and the drive motor and converting a DC voltage converted by the converter into an AC voltage to supply it to the drive motor.

The energy gain of the drive motor may be an energy gain of the inverter which is generated by boosting of the inverter as the converter is operated in the boosting mode.

The controller may derive the energy loss of the converter by using a request output of the drive motor, a switching frequency of the converter, a voltage of the battery and a boosted output voltage of the converter.

The controller may adjust the voltage command of the converter to the voltage of the battery when the energy gain of the drive motor is equal to or less than the energy loss of the converter.

The controller may operate the converter with the boosting mode and adjust the voltage command of the converter to a final voltage command derived by using magnetic flux and a rotational speed of the drive motor and the voltage of the battery when the energy gain of the drive motor is greater than the energy loss of the converter.

Utilizing the control method and system for a converter of a vehicle according to the present disclosure, it is able to reduce the loss of the overall vehicle power conversion system, thereby reducing the heating of the power conversion system, and improve a fuel efficiency of a vehicle by energy efficiency rising.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a flow chart of a control method of a converter of a vehicle according to an exemplary embodiment of the present disclosure; and

FIG. 2 is a block diagram of a converter system of a vehicle according to an exemplary embodiment of the present disclosure.

### DETAILED DESCRIPTION

Hereinafter, a control method and system of a converter of a vehicle according to a preferred exemplary embodiment of the present disclosure will be described with reference to the accompanying drawings.

A power conversion system including a battery 20, a converter 30, an inverter 50 and a drive motor 10, and so on, may be installed in an eco-friendly vehicle including a hybrid vehicle. The drive motor 10 is connected to a drive shaft to supply a rotational power to the drive shaft such that the vehicle can be moved. The power should be supplied to the drive motor 10 in order to supply a rotational power to the drive shaft 10. The battery 20 is a device for supplying the power to the drive motor 10. The converter 30 and the inverter 50 is the device for appropriately converting the power of the battery 20 into the power of the drive motor 10.

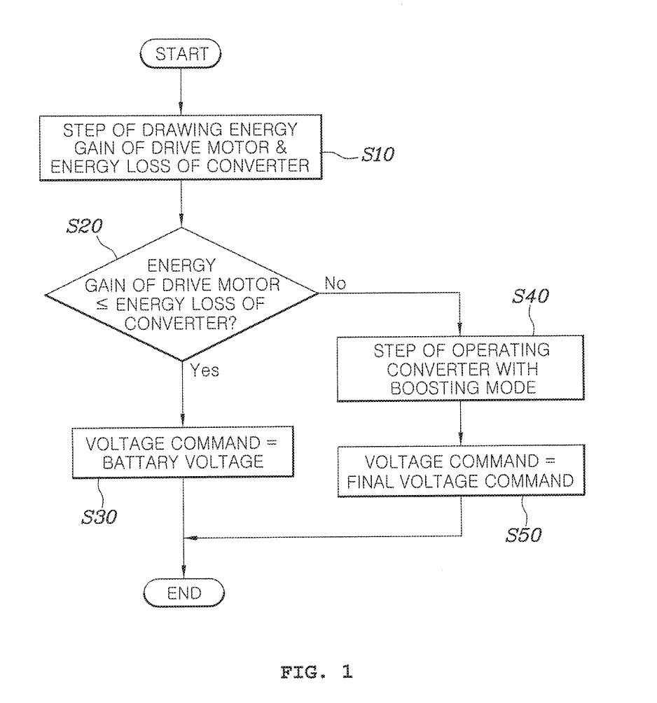

Therefore, a controller 40 controls the power supplied to the drive motor 10 according to the request output of a vehicle by appropriately controlling the converter 30 and the inverter 50. In the present disclosure, it is proposed, as the control method of controlling the converter 30, the step S10 of deriving an energy gain of the drive motor 10 and an energy loss of the converter 30 in the controller 40 in case that the converter 30 constituting a power conversion system of a vehicle is operating in a boosting mode as shown in FIG. 1. In an exemplary embodiment of the present disclosure, the controller 40 may be an electronic control unit (ECU).

The converter 30 used in a vehicle is able to be operated as the boosting mode, as needed, which pertains to the case of not supplying sufficient voltage to the drive motor 10 with only the voltage of the battery 10 because the request output of a vehicle is very large. However, the energy loss is increased in the converter 30 as the converter 30 is operated in the boosting mode, apart from that the voltage supplied to the drive motor 10 increases so that a rotational speed, and so on, of the drive motor 10 increases to raise the energy gain of the drive motor 10.

Therefore, as it is not necessary to increase the energy gain of the drive motor 10 by increasing a supply voltage supplied to the drive motor 10 in case that it is able to satisfy the request output of a vehicle with the voltage of the present drive motor 10, at this case, the boosting mode of the converter 30 may not be used in terms of the overall efficiency of the power conversion system. Therefore, the present disclosure performs the step S10 of deriving the energy gain of the drive motor 10 and the energy loss of the converter 30 as a prerequisite step for comparing the energy gain of the drive motor 10 with the energy loss of the converter 30 generated as the converter 30 is operated in the boosting mode.

The energy gain of the drive motor 10 can be derived through various methods such as the method of using a rotational speed or torque of the drive motor 10, and so on. However, the energy gain of the drive motor 10 in the sense of the present disclosure can be considered as the energy gain depending on the boosting of the converter 30 rather than the energy gain generated by the actual increasing of the rotational speed of the drive motor 10. Therefore, the method of obtaining the energy gain of the drive motor 10 by the actual operation of the drive motor 10 may cause an inaccurate value by a friction force loss depending on the operation of the drive motor 10 or the loss in the process of being passed from the converter 30 to the drive motor 10, and so on.

Therefore, in the present disclosure, the method for deriving the gain of the drive motor 10 exactly without loss generated by the boosting of the converter 30 uses the energy gain of the inverter 50 connected between the drive motor 10 and the converter 30. The inverter 50 is a device for converting the boosted voltage of the converter 30 into AC voltage. If the voltage of the converter 30 is boosted, the voltage applied to the inverter 50 is boosted as much again, and thus, deriving the energy gain of the inverter 50 can be considered to be the same as the energy gain according to the boosting of the converter 30.

That is, in the present disclosure, by comparing the energy gain of the inverter 50 before the converter 30 operates into the boosting mode with the energy gain of the inverter 50 after the converter 30 operates into the boosting mode and obtaining the difference value, the energy gain of the drive motor 10 described above can be derived.

On the other hand, the energy loss of the converter 30 can be derived by using a request output of the drive motor 10, a switching frequency of the converter 30, a voltage of the battery 20 and a boosted output voltage of the converter 30. Concretely, the larger the difference between the request output of the drive motor 10, the switching frequency of the converter 30, the voltage of the battery 20 and the boosted output voltage of the converter 30 become, the larger the energy loss of the converter 30 will become. The energy loss of the converter 30 can be derived by using map data inputting the request output of the drive motor 10, the switching frequency and the output voltage of the converter 30.

In this way, if the energy gain of the drive motor 10 and the energy loss of the converter 30 are derived, the controller 40 may change a voltage command of the converter 30 according to whether the energy gain of the drive motor 10 is equal to or less than the energy loss of the converter 30 or not, through a step S20 of comparing the energy gain with the energy loss as shown in FIG. 1.

Concretely, in case that the energy gain of the drive motor 10 is equal to or less than the energy loss of the converter 30, the controller 40 performs a step S30 of adjusting the voltage command of the converter 30 to the voltage of the battery 20. As described above, in case that the energy gain of the drive motor 10 is equal to or less than the energy loss of the converter 30, it is not necessary to boost the voltage of the battery 20 by using the converter 30. Furthermore, even in case that the energy gain of the drive motor 10 is equal to the energy loss of the converter 30 in accordance with the conditions, the controller 40 adjusts the voltage command of the converter 30 to the voltage of the battery 20. This is because the efficiency of the converter 30 lowers by resonant phenomenon as well as the temperature of the converter 30 rises as an inductor or a capacity in the converter 30 should operate in case of operating the converter 30 into the boosting mode. Therefore, even in case that it is determined that the energy gain of the drive motor 10 is equal to the energy loss of the converter 30, the controller 40 adjusts the voltage command of the converter 30 to the voltage of the battery 20 without the need to operate the converter 30 into the boosting mode.

On the contrary to this, in case that the energy gain of the drive motor 10 is more than the energy loss of the converter 30, the converter 30 may be operated into the boosting mode. Therefore, in this case, the controller 40 performs a step S40 of operating the converter 30 into the boosting mode and a step S50 of adjusting the voltage command of the converter 30 to a final voltage command derived by using the magnetic flux and a rotational speed of the drive motor 10 and the voltage of the battery 20.

In this regard, the final voltage command means an output voltage which the converter 30 aims, and can be derived by a map data inputting the magnetic flux and a rotational speed of the drive motor 10 and the voltage of the battery 20 and outputting the final voltage command. Furthermore, the magnetic flux of the drive motor 10 can be derived by using driving conditions of a vehicle and the temperature of the drive motor 10. Therefore, the final voltage command corresponds to the voltage command of the converter 30 in case that the converter 30 operates into the boosting mode such that it will have the value larger than the voltage of the battery 20 and will be appropriately decided through the controller 40 within the scope of satisfying the request output of a vehicle.

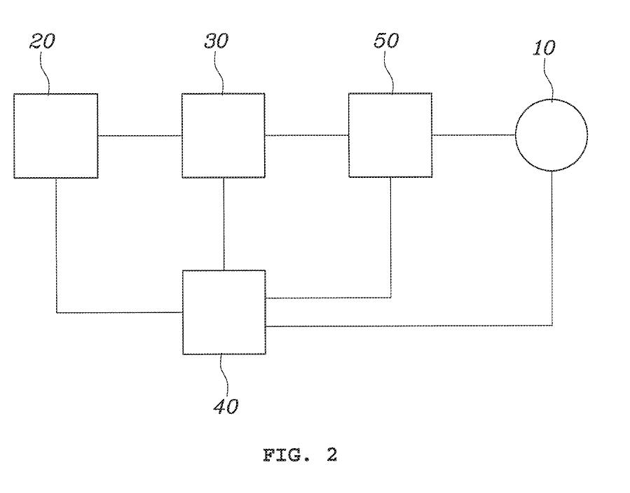

Furthermore, the converter system of a vehicle according to the present disclosure, as shown in FIG. 2, may include the drive motor 10 supplying a rotational power to a drive shaft of a vehicle; a chargeable and dischargeable battery 20; the converter 30 being connected between the drive motor 10 and the battery 20 and converting an output voltage of the battery 20 into an operating voltage for operating the drive motor 10; the controller 40 deriving an energy gain of the drive motor 10 and an energy loss of the converter 30 in the case that the converter 30 is operating into the boosting mode, comparing the energy gain of the drive motor 10 with the energy loss of the converter 30, and adjusting a voltage command of the converter 30 depending on the comparison result; and the inverter 50 being connected between the converter 30 and the drive motor 10 and converting a DC voltage converted by the converter 30 into an AC voltage to supply it to the drive motor 10.

Although the exemplary embodiments of the present disclosure have been disclosed for illustrative purposes, those skilled in the art will appreciate that various modifications, additions and substitutions are possible, without departing from the scope and spirit of the invention as disclosed in the accompanying claims.

What is claimed is:

1. A control method of a converter of a vehicle, the method comprising steps:
deriving, by a controller, an energy gain of a drive motor and an energy loss of a converter when the converter is operating in a boosting mode;
comparing, by the controller, the energy gain of the drive motor with the energy loss of the converter; and
adjusting, by the controller, a voltage command of the converter depending on a comparison result.

2. The control method of claim 1, wherein the energy gain of the drive motor is an energy gain of an inverter which is generated by boosting of the inverter connected between the drive motor and the converter as the converter is operated in the boosting mode.

3. The control method of claim 1, wherein the energy loss of the converter is derived on basis of a request output of the drive motor, a switching frequency of the converter, a battery voltage, and a boosted output voltage of the converter.

4. The control method of claim 1, wherein the step of adjusting the voltage command of the converter is that the controller adjusts the voltage command of the converter to the battery voltage when the energy gain of the drive motor is equal to or less than the energy loss of the converter.

5. The control method of claim 1, wherein, in the step of adjusting the voltage command of the converter, the controller operates the converter with the boosting mode and adjusts the voltage command of the converter to a final voltage command derived by using magnetic flux and a rotational speed of the drive motor and the battery voltage when the energy gain of the drive motor is greater than the energy loss of the converter.

6. A converter system of a vehicle, comprising:
a drive motor supplying a rotational power to a drive shaft of a vehicle;
a chargeable and dischargeable battery;
a converter connected between the drive motor and the battery and converting an output voltage of the battery into an operating voltage for operating the drive motor; and
a controller deriving an energy gain of the drive motor and an energy loss of the converter when the converter is operating into a boosting mode, comparing the energy gain of the drive motor with the energy loss of the converter, and adjusting a voltage command of the converter depending on a comparison result.

7. The converter system of claim 6, further comprising:
an inverter connected between the converter and the drive motor and converting a DC voltage converted by the converter into an AC voltage to supply the AC voltage to the drive motor.

8. The converter system of claim 7,
wherein the energy gain of the drive motor is an energy gain of the inverter which is generated by boosting of the inverter as the converter is operated in the boosting mode.

9. The converter system of claim 6,
wherein the controller derives the energy loss of the converter by using a request output of the drive motor, a switching frequency of the converter, a voltage of the battery, and a boosted output voltage of the converter.

10. The converter system of claim 6,
wherein the controller adjusts the voltage command of the converter to the voltage of the battery when the energy gain of the drive motor is equal to or less than the energy loss of the converter.

11. The converter system of claim 6,
wherein the controller operates the converter with the boosting mode and adjusts the voltage command of the converter to a final voltage command derived by using magnetic flux and a rotational speed of the drive motor and the voltage of the battery when the energy gain of the drive motor is greater than the energy loss of the converter.
